(19) United States
(12) Patent Application Publication
(10) Pub. No.: US 2006/0040012 A1
(43) Pub. Date: Feb. 23, 2006

(54) Ball mold

(76) Inventors: Kuang-Hui Su, Sanchung City (TW); Tse-Hui Lei, Sanchung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/921,887

(22) Filed: Aug. 20, 2004

(51) Int. Cl. B29C 33/42

(52) U.S. Cl. 425/470

(57) ABSTRACT

A ball mold is composed of two half bodies and two hemispherical cavities respectively defined in the two half bodies to correspondingly match with each other to perform a ball-shaped interior inside the ball mold. Each of the two half bodies has an inner surface, at least one smooth area and at least one rough area; both areas are defined in the inner surface. Preferably, the smooth area has a gouged depth deeper than that of the rough area. Therefore, a ball molded by the ball mold has rough elevated portions corresponding to the rough areas on the ball mold and smooth recesses corresponding to the smooth areas on the ball mold. The ball only needs to be attached with pieces of artificial leather inside smooth recesses to be flush with the rough elevated portions. Thereby, the ball with two different surfaces is achieved in a convenient way without thermal pressing.

### BACKGROUND OF THE INVENTION

1. Field of the Invention

The present invention relates to a ball mold, and more particularly a ball mold that conveniently manufactures a ball having two different surfaces in a simplified process.

2. Description of Related Art

Inflatable balls, such as a basketball or a volleyball, are basically composed of multiple layers including an inner body with an interior, a fabric layer, an intermediate layer and a coat. When manufacturing the inflatable ball, a string surrounds the inner body to form the fabric layer to protect the inner body. The inner body with the fabric layer is placed into a conventional mold. Then, vulcanized rubber liquid is poured into the conventional mold to surround the fabric layer to form the intermediate layer. An inlet nozzle penetrates through the intermediate layer and the fabric layer to communicate with the interior of the inner body. After the intermediate layer has solidified, the outer periphery of the intermediate layer is trimmed, cleaned and eroded to make the outer periphery have more adhesive capability. Multiple pieces of artificial leather are then attached on the outer periphery of the intermediate layer. Selectively, the outer periphery of the intermediate layer is thermally pressed to form multiple grains thereon to construct rough areas for convenient holding.

With reference to FIGS. 4 and 5, the conventional mold for manufacturing the inflatable ball is composed of a first body (31) with a first hemispherical cavity, a second body (32) with a second hemispherical cavity and an injection hole (35). The first and second bodies (31, 32) combine together to make the first and second hemispherical cavities into a ball-shaped interior. The injection hole is defined in one of the two bodies (31, 32) to communicate with the ball-shaped interior. Each hemispherical cavity has a smooth inner surface (33) so that the intermediate layer has a smooth surface after being molded.

The smooth surface of the intermediate layer is divided into multiple areas and respectively treated to perform different tactile sensations to the ball. Preferably, some of the areas are thermally pressed to form a rough surface with multiple grains. The other areas are adhered with multiple pieces of artificial leather to form smooth surfaces. Therefore, manufacturers need to carry out several manufacturing processes to make the ball with two different surfaces. Additionally, the attached artificial leather causes bulges on the surface of the ball so that the ball with two different surfaces is uneven which may have a serious effect on the ball's behavior.

To overcome the shortcomings, the present invention tends to provide a modified ball mold to mitigate and obviate the aforementioned problems.

### SUMMARY OF THE INVENTION

The main objective of the invention is to provide a ball mold that simplifies manufacturing processes of making a ball with two different surfaces.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a ball mold in accordance with the present invention;

FIG. 2 is a partially cross-sectional perspective view of a half body in the ball mold in FIG. 1;

FIG. 3 is a cross-sectional side plane view of the half body along line 3-3 in FIG. 1;

FIG. 4 is a perspective view of a conventional ball mold in accordance with the prior art; and

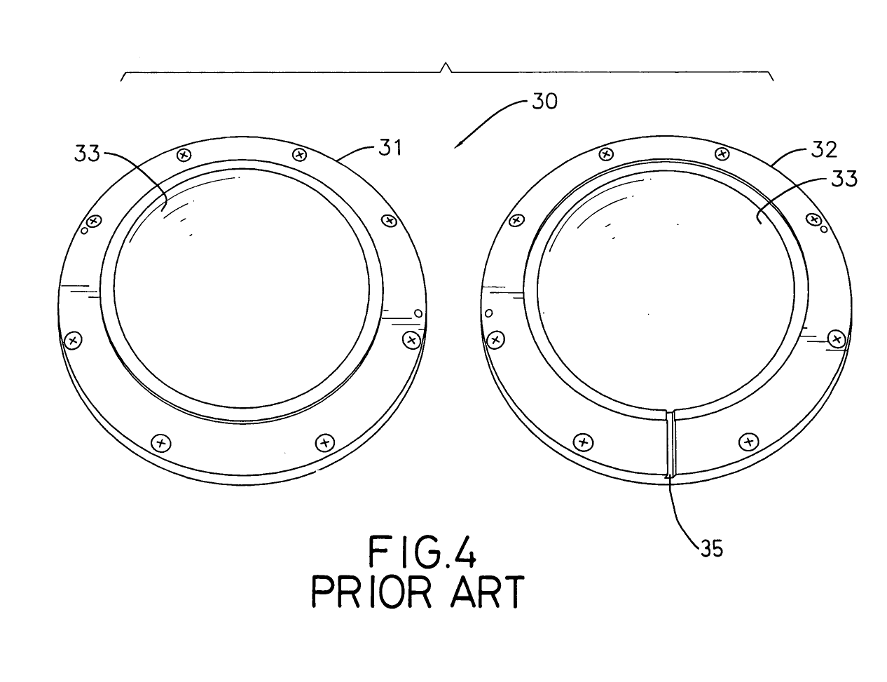

FIG. 5 is a cross-sectional side plane view of the conventional ball mold in FIG. 4.

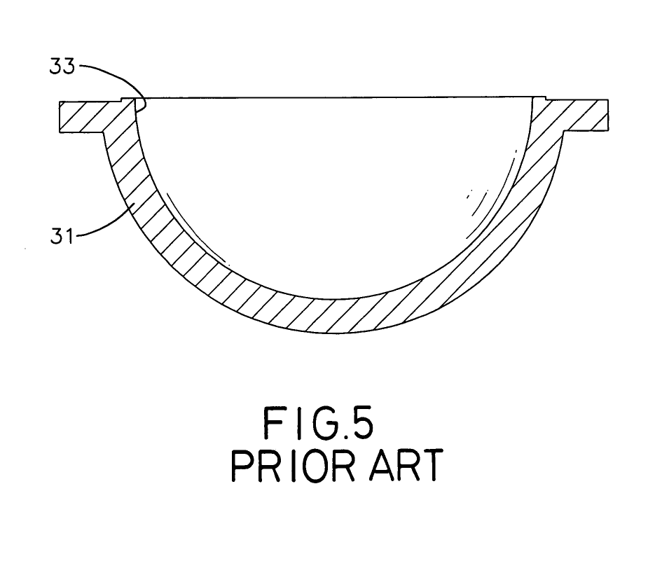

### DETAILED DESCRIPTION OF PREFERRED EMBODIMENT

A ball mold in accordance with the present invention comprises two half bodies, two hemispherical cavities respectively defined in the two half bodies and corresponding with each other to perform a ball-shaped interior. Each of the two half bodies has an inner surface and at least one smooth area and at least one rough area; both areas are defined in the inner surface. Preferably, each smooth area has a gouged depth deeper than that of the rough area. Therefore, a ball molded by the ball mold has rough elevated portions corresponding to the rough areas on the ball mold and smooth recesses corresponding to the smooth areas on the ball mold. The ball only needs to be attached with pieces of artificial leather inside smooth recesses to be flush with the rough elevated portions. Thus, the ball with two different surfaces is achieved in a simplified way without thermal pressing.

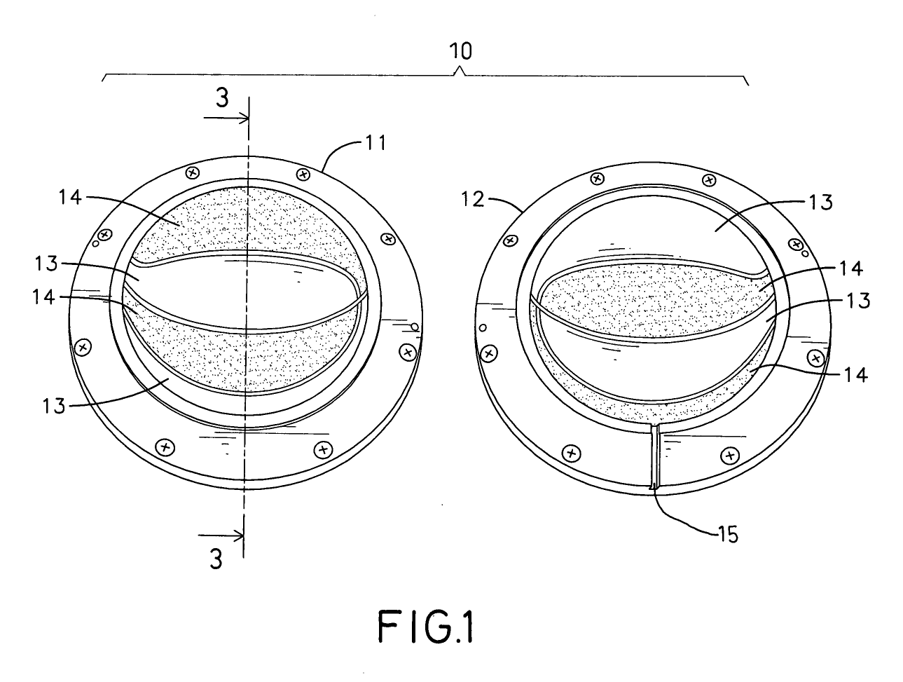

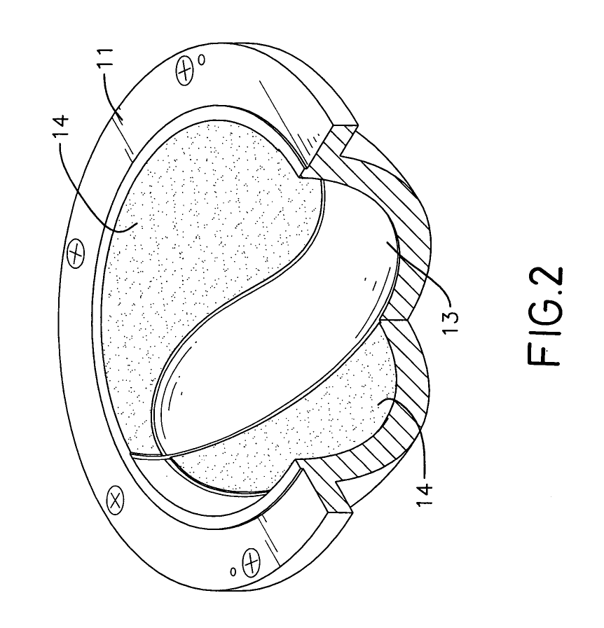

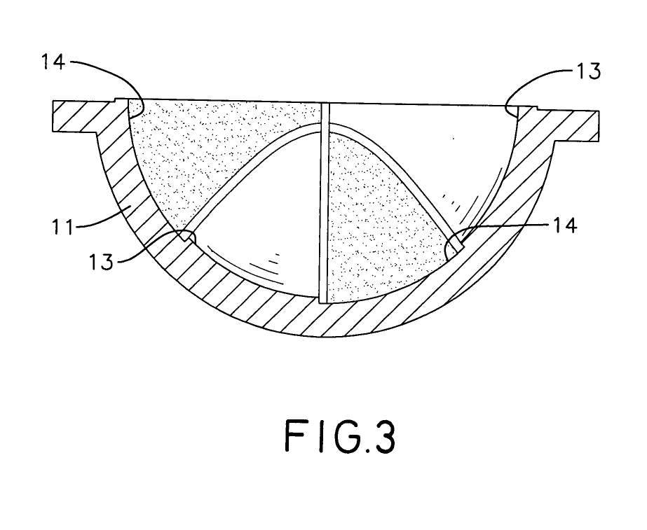

With reference to FIG. 1 to 3, a preferred embodiment of the ball mold (10) in the present application comprises two matching half bodies (11, 12).

Each of the half bodies (11, 12) has a hemispherical cavity defined in the half body. When the two half bodies are combined, the two hemispherical cavities provide a ball-shaped interior inside the ball mold (10). Each hemispherical cavity has an inner surface and at least one rough area (14) and at least one smooth area (13) defined in the inner surface. Each rough area (14) has a rough surface and multiple grains formed on the rough surface of the rough area (14). Each smooth area (13) is gouged to have a depth deeper than a depth of the rough area and has a smooth surface formed in a bottom of the smooth area. Therefore, when a ball is molded inside the ball mold (10), the ball has at least one rough elevated portion formed in one corresponding rough area (14) on the ball mold (10) and at least one smooth recess formed in one corresponding smooth area (13) on the ball mold (10). Particularly, one of the two half bodies has an injection hole (15) defined through the half body (12) to communicate with the interior of the ball mold (10).

Preferably, each hemispherical cavity has two rough areas (14) and two smooth areas (13) alternatively defined on the inner surface in an even arrangement.

Molding the ball with two different surfaces in the ball mold (10) of the present invention has basically same procedures as described in the prior art. An inner inflatable body with a fabric layer is placed into the ball mold (10) and then a vulcanized rubber liquid is injected into the interior of the ball mold (10) via the injection hole (15) to form an intermediate layer surrounding the inflatable body. When the intermediate layer has solidified, multiple rough elevated portions and multiple smooth recesses are formed on the intermediate layer around the ball. Lastly, pieces of artificial leather are correspondingly attached to the ball in the smooth recesses to achieve the ball with two different surfaces. Because the smooth recesses are lower than the rough elevated portion, the pieces of artificial leather fill the smooth recesses whereby the finished product has an even spherical periphery with multiple portions divided into two different textures. In comparison with the manufacturing processes of making the ball by the conventional mold, a step of thermal pressing the intermediate layer is obviated because the rough areas in the ball mold (10) make the rough surfaces on the rough elevated portions when molding. Therefore, the manufacturing process of the ball with two different surfaces is simplified by using the ball mold (10) in the present invention.

It is to be understood however that even though numerous characteristics and advantages of the present invention have been set forth in the foregoing description together with details of the structure and function of the invention, the disclosure is illustrative only, and changes may be made in detail, especially in variation of the arrangement of the rough areas (14) and the smooth areas (13) within the principles of the invention to the full extent indicated by the broad general meaning of the terms in which the appended claims are expressed.

What is claimed is:

1. A ball mold comprises:
two half bodies;
two hemispherical cavities respectively defined in the two half bodies and corresponding with each other to provide a ball-shaped interior; and
an injection hole defined in one of the two half bodies to communicate with the ball-shaped interior;
wherein, each hemispherical cavity has an inner surface, at least one smooth area defined in the inner surface and at least one rough area defined in the inner surface.

2. The ball mold as claimed in claim 1, wherein each smooth area has a gouged depth deeper than a depth of the at least one rough area.

3. The ball mold as claimed in claim 1, wherein the each hemispherical cavity has two smooth areas and two rough areas alternatively defined in the inner surface.

4. The ball mold as claimed in claim 2, wherein the each hemispherical cavity has two smooth areas and two rough areas alternatively defined in the inner surface.
